(19) United States
(12) Patent Application Publication
(10) Pub. No.: US 2003/0182973 A1
(43) Pub. Date: Oct. 2, 2003

(54) Flame guide unit for burner

(76) Inventor: Gu-Young Kang, Kumi-shi (KR)

Correspondence Address: CHA & REITER, 411 HACKENSACK AVE, 9TH FLOOR, HACKENSACK, NJ, 07601, US

(21) Appl. No.: 10/264,871

(22) Filed: Oct. 4, 2002

(30) Foreign Application Priority Data
Mar. 29, 2002 (KR) 2002-17289

(51) Int. Cl. C03B 37/028

(52) U.S. Cl. 65/501

(57) ABSTRACT

Disclosed in the present invention is a flame-guide unit for a burner used in an over-jacketing device for processing an optical-fiber preform with a large diameter, wherein the over-jacketing device is mounted with a burner and includes at least two closely-located suctions on the upper portion and lower portion of the burner, the flame-guide unit including a hollow flame guide that surrounds the prepared optical-fiber preform, being extended from the burner as one body, to preheat the optical-fiber preform by extending the heat-convection interval generated by the flame of the burner along a longitudinal direction of the optical-fiber preform, thereby improving heat radiation for more effective heating.

### CLAIM OF PRIORITY

This application makes reference to and claims all benefits accruing under 35 U.S.C. Section 119 from an application entitled, “Flame Guide Unit for Burner,” filed in the Korean Industrial Property Office on Mar. 29, 2002 and there duly assigned Serial No. 2002-17289.

### BACKGROUND OF THE INVENTION

1. Field of the Invention

The present invention relates generally to an optical-fiber-perform-manufacturing device and, in particular, to an over-jacketing device for manufacturing an optical fiber.

2. Description of the Related Art

In general, an optical-fiber-manufacturing method is divided into two-step approaches. The first step involves preparing an optical-fiber preform, and the second step involves drawing an optical fiber having an outer diameter of 125 μm by melting the prepared optical-fiber preform.

The method for preparing an optical preform is largely divided into a vapor-deposition method and a sol-gel method. The vapor-deposition method is disclosed in Korean Patent No. 99-60184 (Dec. 22, 1999) applied by the present applicant, and the sol-gel method is disclosed in Korean Patent No. 99-21366 (Jun. 9, 1999) again applied by the present applicant.

The optical-fiber-drawing process typically involves drawing a thread of optical fiber having the outer diameter of 125 μm from a molten preform by applying a fixed tension and load on the preform. However, there is a drawback in this process, especially when an optical-fiber preform with a large diameter needs to be manufactured. Particularly, if a modified-chemical-vapor-deposition (MCVD) method is used, it is difficult to get an optical-fiber preform having its diameter longer than about 25 mm. Therefore, the over-jacketing method has been used instead to overcome this problem and to improve productivity, in which a previously prepared, optical-fiber preform was put into a glass tube having a large diameter, then heated on a burner to be melted. Thereafter, the optical-fiber preform and the glass tube are later bonded together, allowing the manufacture of an optical-fiber preform with a large diameter.

FIG. 1 is a perspective view of an over-jacketing manufacturing device 100 for an optical-fiber preform according to one embodiment of the related art. FIG. 2 is a cross-sectional diagram explaining a burner for the over-jacketing manufacturing device 100 of optical preform shown in FIG. 1. As depicted in FIGS. 1 and 2, the over-jacketing manufacturing device 100 of the optical-fiber preform according to one embodiment of the related art includes a vertical lathe 110 containing chucks 111 and 113 to provide means for vertically installing a coaxial optical-fiber preform and the glass tube 101; a carriage 117 installed in the lathe 110, which moves vertically; a burner 120 installed in the carriage 117, which heats the optical-fiber preform and the glass tube 101 by combusting oxygen and hydrogen; a vacuum pump 103 connected to the chucks 111 and 113 of one end of the vertical lathe 110; a coupling (not shown) for connecting the vacuum pump 103; and a controller (not shown) for controlling the rotation of the optical-fiber preform and the glass tube 101 that are caught by the chucks 111 and 113, the vertical-motion speed of the carriage 117, the oxygen and hydrogen flow, and the pressure of the vacuum pump.

As shown in FIG. 1, the vertical lathe 110 includes a transfer means (not shown) for transferring the carriage 117, a guide rod 115, an upper chuck 111 and a lower chuck 113 installed at both ends of the vertical lathe 110. The upper chuck 111 fixates the optical-fiber preform (which is inserted into the glass tube) and rotates the same, and the lower chuck 113 fixates the glass tube 101 and rotates the glass tube 101.

On the lathe 110, the carriage 117 mounted with the burner 120 makes a vertical motion with respect to the axis of the guide rod 115. In addition, ventilating suctions 131a, 131b, 133a, and 133b that are extendable and contractible are installed in the top portion and the bottom portion of the burner 120 in order to keep the flame from being spread to the outside. That is, the burner 120 and the suctions 131a-133b are stacked up by the carriage 117 so that the burner 120 and the suctions 131a-133b can make the vertical motion as one body according to the carriage 117 motion.

The over-jacketing manufacturing device 100 of the optical-fiber preform coaxially arranges the optical-fiber preform and the glass tube 101 on the upper end and the lower end of the chucks 111 and 113, while providing heat with the burner 120. When the optical-fiber preform and the glass tube 101 are softened, the vacuum pump 103 eliminates any remaining gas between the optical-fiber preform and the glass tube 101, thereby sealing the optical-fiber preform and the glass fiber 101 together.

The flame or heat generated by the burner 120 is applied to the optical-fiber preform and the glass tube 101, then discharged to the outside through the ventilating suctions 131a-133b. At this time, the lower suctions 133a and 133b are spaced apart by a designated distance to preheat the optical-fiber preform and the glass tube 101 while the flame or heat are progressing to the lower end of the device 10.

However, the prior-art device has problems with heating, in which the heat generated by the burner 120 cannot heat the optical-fiber preform and the glass tube 101 sufficiently enough as the part of the heat is discharged through the ventilating device, i.e., the suction devices or is emitted to the outside. As a result, the productivity suffers because the motion speed of the burner must be slowed down to heat the optical-fiber preform and the glass tube 101 sufficiently enough, and much more fuel is consumed to maintain or improve the productivity. Moreover, in case of using a glass tube with a large diameter, the motion speed of the burner is far slower, and if more oxygen and hydrogen are supplied to increase heat generation. As such, the external surface of the glass tube could be too softened while the internal surface of the glass tube is not heated sufficiently. If the oxygen and hydrogen supply is increased, the glass tube's shape may be deformed by the burner's injection pressure. Furthermore, as the flame or heat from the burner is discharged to a specific direction by the ventilating suction units, the optical-fiber preform and the glass tube may not be equally heated.

### SUMMARY OF THE INVENTION

The present invention relates to a flame-guide unit for a burner, which is capable of improving the heat efficiency of the burner when heating an optical-fiber preform.

One aspect of the present invention is to improve the optical fiber's quality by equally heating the optical-fiber preform and glass tube during the manufacturing of an optical-fiber perform according to an over-jacketing process.

Another aspect of the present invention is to provide a flame-guide unit for a burner used in an over-jacketing device for manufacturing an optical-fiber preform having a large diameter, wherein the over-jacketing device is mounted with a burner and prepared by providing a flame and at least two closely-located suctions on the upper portion and lower portion of the burner. The flame-guide unit includes a hollow flame guide that surrounds the prepared optical-fiber preform, being extended from the burner as one body, and used to preheat the optical-fiber preform by extending a heat-convection interval which is generated by the flame of the burner to a longitudinal direction of the optical-fiber preform, thereby improving the heat radiation to produce more effective heating.

### BRIEF DESCRIPTION OF THE DRAWINGS

The above features and advantages of the present invention will become more apparent from the following detailed description when taken in conjunction with the accompanying drawings in which:

FIG. 1 is a perspective view of an over-jacketing manufacturing device of the optical-fiber preform in accordance with one embodiment of the related art;

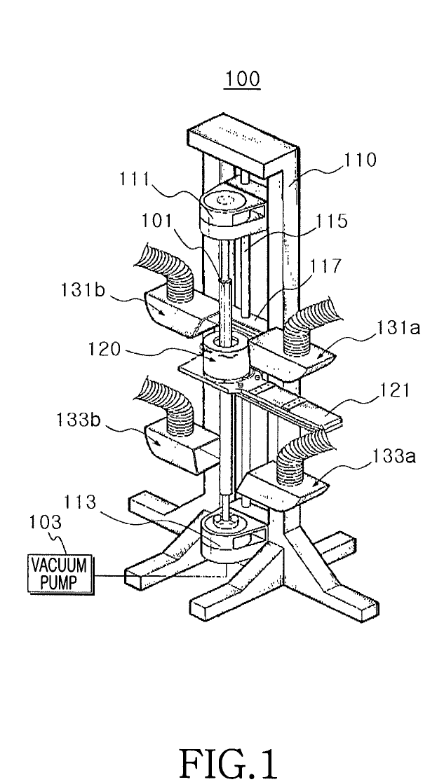

FIG. 2 is a cross-sectional view explaining the over-jacketing manufacturing device of an optical-fiber preform illustrated in FIG. 1;

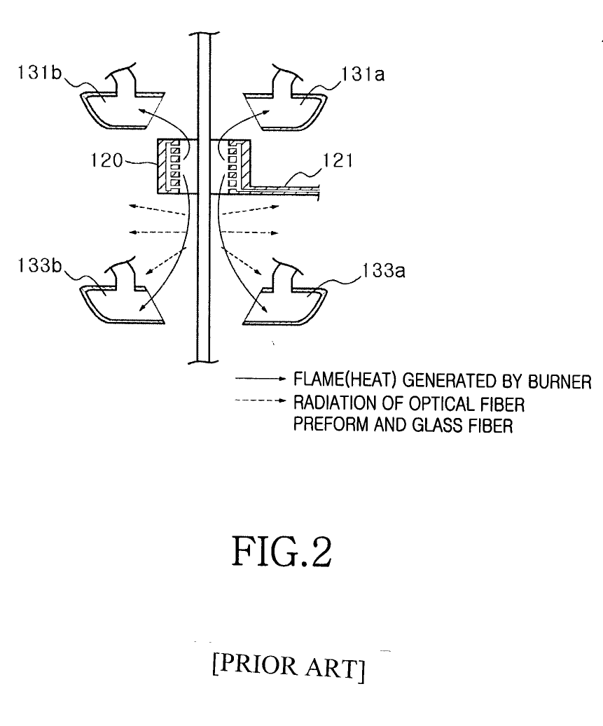

FIG. 3 is a perspective view of an over-jacketing manufacturing device of an optical-fiber preform, mounted with a flame-guide unit for a burner in accordance with a preferred embodiment of the present invention; and,

FIG. 4 is a cross-sectional view explaining the flame-guide unit in the over-jacketing manufacturing device of an optical-fiber preform illustrated in FIG. 3.

### DETAILED DESCRIPTION OF THE PREFERRED EMBODIMENT

In the following description, for purposes of explanation rather than limitation, specific details are set forth such as the particular architecture, interfaces, techniques, etc., in order to provide a thorough understanding of the present invention. For purposes of simplicity and clarity, detailed descriptions of well-known devices, circuits, and methods are omitted so as not to obscure the description of the present invention with unnecessary detail.

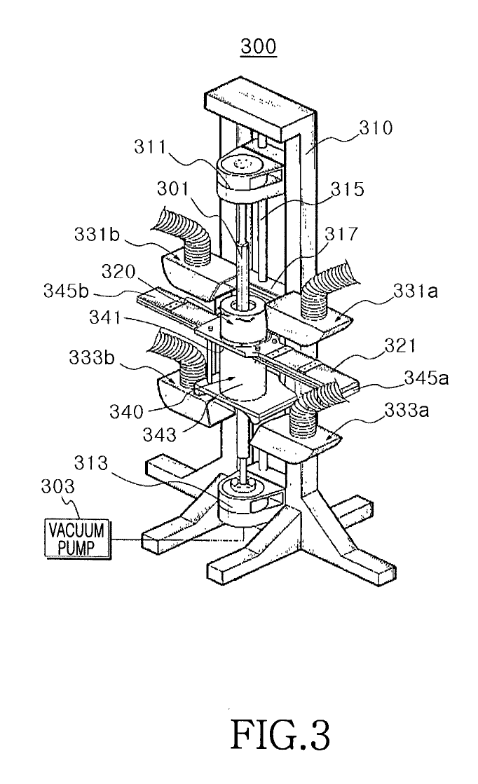

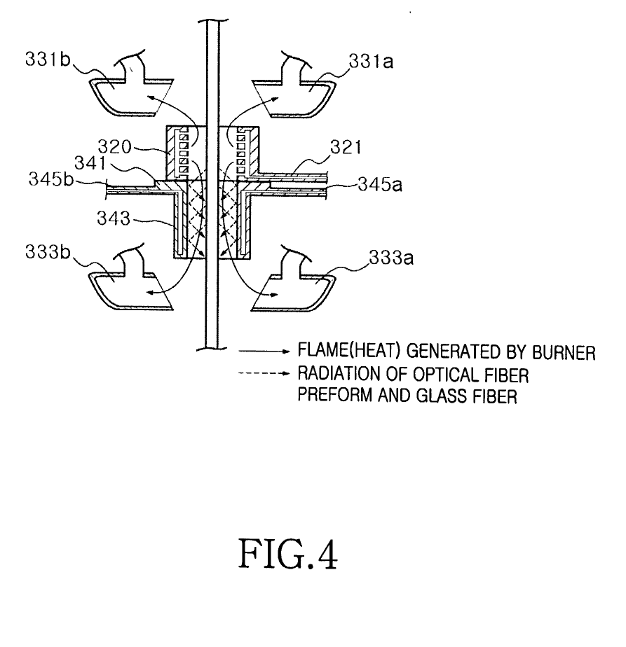

FIG. 3 is a perspective view of the over-jacketing manufacturing device 300 of an optical-fiber preform, mounted with a flame-guide unit 340 for a burner in accordance with a preferred embodiment of the present invention, and FIG. 4 is a cross-sectional view explaining the flame-guide unit 340 in the over-jacketing manufacturing device 300 of an optical-fiber preform illustrated in FIG. 3. As depicted in the drawing, the over-jacketing manufacturing device 300 of an optical-fiber preform includes a burner 320, a first and second suctions 331a, 331b, 333a, and 333b located at both ends of the burner 320, being distant from each other, and a flame-guide unit 340 having a designated length installed in the burner 320, wherein the burner 320, the first and second suctions 331a, 331b, 333a, and 333b, and the flame-guide unit 340 on a designated vertical lathe 310 can move along with the longitudinal direction of the optical-fiber preform and glass tube 301 that are mounted on the lathe 310.

To install the optical-fiber preform and the glass tube 301, the lathe 310 includes chucks 311 and 313 at the upper portion and the lower portion, respectively. The upper chuck 311 and the lower chuck 313 rotate the optical-fiber preform and glass tube 301 at a constant speed during the over-jacketing process to equally heat the optical-fiber preform (which is being inserted into the glass tube, not shown) and glass tube 301 along with the tube's circumference direction. Moreover, a vacuum pump 303 is connected to either the upper chuck 311 or lower chuck 313. In a preferred form, the vacuum pump 303 is connected to the lower chuck 313. When the optical-fiber preform and glass tube 301 are sufficiently heated and softened, the vacuum pump 303 seals them by getting rid of gas that might exist between the optical-fiber preform and the glass tube 301.

In addition, the lathe 310 includes a designated guide rod 315 and a carriage 317 that move to a vertical direction by a transfer means (not shown), so it provides a means for installing the burner 320, and the first and second suctions 331a-333b, and for moving them to the longitudinal direction of the glass tube 301. Although the flame-guide unit 340 is joined to the burner 320 in the present invention, it can be directly installed in the carriage 317 as well.

The burner 320 is used for heating the optical-fiber preform and the glass tube 301 to their softening points. The typically-used burner is a ring-type burner which heats the optical-fiber preform and the glass tube 301 by combusting oxygen and hydrogen that are provided from the outside. Usually, the burner is installed in the carriage 320 and makes a rectilineal motion along with the longitudinal direction of the glass tube 301. The ring-type burner 320 is particularly used because it can equally heat the optical-fiber preform and the glass tube 301 mounted at the lathe 310, along its circumference direction.

The first suctions 331a and 331b are disposed to be distant from one end, preferably the upper end, of the burner 320, and discharge the flame or heat generated by the burner 320 to the outside to protect other units from the heat. The second suctions 333a and 333b are disposed to be distant from the other end, preferably the lower end, of the burner 320. Note that the second suctions are disposed farther than the distance between the first suctions 331a and 331b and the burner 320. In such a way, while progressing to the lower portion, the heat from the burner 320 sticks around the optical-fiber preform and the glass tube 301 long enough to preheat them then later discharged through the second suctions 333a and 333b.

The flame-guide unit 340 has a cylinder shape whose both ends are open and is joined to the lower end of the burner 320. Usually, the flame-guide unit 340 is placed between the burner 320 and the second suctions 333a and 333b. Although the flame-guide unit 340 is joined to the lower end of the burner 320 in the present invention, it can be directly installed on the carriage 317 of the lathe while maintaining the junction with the burner 320 at the same time.

The flame-guide unit 340 includes a flange 341 for joining the unit with the lower end of the burner 320, a guide body 343 extended from the flange 341 having a cylinder shape whose both ends are open, and a cooler 345 for preventing the guide body 343 from being overheated to higher than a designated temperature. The cooler 345 includes an entrance opening 345a and a drainage opening 345b and is capable of supplying or discharging cooling water continuously by providing a designated path where the cooling water can progress to inside the guide body 343. As the flange 341 is joined to the lower end of the burner 320 through welding or using a thread, the heat from the burner 320 is not lost on the outside but progresses to the inside of the guide body 343, thus preheating the optical-fiber preform and glass tube 301 sufficiently. Then, the heat is discharged to the outside through the second suctions 333a and 333b. The flame-guide unit 340, more specifically the length of the guide body 343, does not exceed the distance between the burner 320 and the second suctions 333a and 333b. The flame-guide unit 340 keeps the flame or heat from the burner 320 as well as the radiation heat emitted from the heated optical-fiber preform and glass tube 301 from being emitted to the outside of the flame-guide unit 340, thereby extending the heat-convection interval between the burner 320 and the second suctions 333a and 333b. Therefore, by making the guide body 343 of the thermal-insulation material or performing the internal surface process on the guide body 343, the thermal efficiency of the over-jacketing manufacturing device can be improved much more effectively. The radiant heat of the burner 320 is insulated in the flame guide unit 340 by the thermal insulation material or the radiant heat of the burner 320 is reflected by the internal surface of the flame guide unit 340.

As explained, the heat generated by the burner 320 progresses inside the guide body 343 and sufficiently preheats the optical-fiber preform and the glass tube 301. Note that the temperatures of the outside surface and the inside surface of the glass tube 301 are not that much different from each other; thus, the outside surface is not necessarily too softened before the inside surface is heated. In operation, the heating process is first carried out on the upper portion of the optical-fiber preform and the glass tube 301 that are fixed on the lathe 310 and then on the lower portion.

Now, the over-jacketing process using the over-jacketing manufacturing device 300 of an optical-fiber preform is explained hereinafter.

First of all, the optical fiber perform is coaxially arranged to be perpendicular at the upper chuck 311 of the lathe 310 through leveling, then a dummy tube (not shown) is connected to one end of the glass tube 301 and the dummy tube is coaxially arranged to be perpendicular at the lower chuck 313 through the leveling. Upon completion of the coaxial arranging the optical fiber perform and the glass tube 301, the optical perform is inserted to the glass tube 301.

Next, by driving the upper and the lower chucks 311 and 313, the combined optical-fiber preform and glass tube 301 are rotated at 20 to 30 RPM, and by using the burner 320, the heating process proceeds slowly starting from the upper end of the optical-fiber preform and glass tube 301. Once the optical-fiber preform and the glass tube 301 are softened, the pressure between the optical-fiber preform and the glass tube 301 can be lowered by operating the vacuum pump 303, thereby sealing them together from the upper part. Later, while moving the carriage 317 downward, the burner's calorific value is increased. For example, if a burner uses oxygen and hydrogen as fuel, the oxygen flow should be increased up to 280 LPM and hydrogen flow should be increased up to 380 LPM.

The moving speed of the carriage 317 is slowly increased from 0.4 CPM to 1.5 CPM while moving downward. At this time, the flame or heat generated by the burner 320 preheats the unsealed optical-fiber preform and glass tube 301 while progressing inside the flame-guide unit 340 that is joined with the lower end of the burner 320. As the flame or heat generated by the burner 320 is not emitted to the outside but is used for preheating the optical-fiber preform and the glass tube 301 while progressing inside the flame guide unit 340, the thermal efficiency is much improved.

The optical-fiber preform and the glass tube 301 rotate at a constant speed, and they become one body when they are entirely sealed with each other. Once they are sealed over the full length, the burner is stagnated until the connection portion between the glass tube 301 and the dummy tube become softened. When they are softened, the upper chuck 311 is slowly moved upward at the speed of 1 to 3 mm/min, making the connection portion thin. Later, as the outer diameter of the sealed glass tube 301 becomes ⅔ of the original diameter, the optical-fiber preform and the glass tube 301 are moved to an upper direction quickly, and the preform sealed with the dummy tube is completely disconnected. Then, the complete preform is taken out of the chuck and slowly cooled down for a designated period of time, thus completing the over-jacketing process of the optical-fiber preform.

Meanwhile, Table 1 below illustrates the differences that are observed before applying the inventive flame-guide unit and thereafter. As manifested in Table 1, when the flame-guide unit is used for the burner according to the present invention, the fuel consumption of the over-jacketing device was decreased and, at the same time, the productivity thereof was greatly improved.

TABLE 1

| | | Before the | | | |
|---|---|---|---|---|---|
| | | present | After the present | | |
| | | invention | invention is | | |
| | | is applied | applied | | Effect |
| Fuel | Hydrogen | 450 LPM | 380 | LPM | 15% cut down |
| Consumption | Oxygen | 330 LPM | 280 | LPM | |

| | | | | |
|---|---|---|---|---|
| Processing speed | 1 CPM | 1.5 | CPM | 50% increase |

It should be noted that, although it is not explained before, any skilled people in the related art would understand that the controller for controlling the motion speed of the carriage, heating temperature of the burner, and pressure of the vacuum pump should be included in the device.

In conclusion, the over-jacketing manufacturing device of an optical-fiber preform according to the present invention is very effective for improving the thermal efficiency of the burner by installing the flame-guide unit in the lower portion of the burner that heats the optical-fiber preform and the glass tube, while moving along the longitudinal direction of the optical-fiber preform during the over-jacketing process. Specifically, before carrying out the over-jacketing process by directly heating the optical-fiber preform and the glass tube using the burner, the flame-guide unit guides the heat from the burner to the inside the flame-guide unit to preheat the optical-fiber preform and the glass tube before the heat is emitted to the outside, thereby improving the thermal efficiency of the burner. Meanwhile, the flame-injection pressure of the burner does not need to be increased, unlike the conventional method in which the flame-injection pressure was increased to complete the over-jacketing process within a short time. As a result, the deformation of the glass tube can be prevented. Moreover, before being heated by the burner directly, the optical-fiber preform and the glass tube are equally heated in the guide tube without any influence of the suctions, thus the optical fiber's quality itself can be improved as well.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A flame-guide unit used in an over-jacketing device for processing an optical-fiber preform with a large diameter, comprising:
a burner mounted in the over-jacketing device for applying heat over a glass tube and the optical-fiber perform;
at least two suctions disposed on an upper portion and a lower portion of the burner;
a hollow flame guide extending from one end of the burner and surrounds the glass tube and the optical-fiber preform, the hollow flame-guide operative to keep heat generated by the burner along a longitudinal direction of the optical-fiber perform.

2. The flame guide unit as claimed in claim 1, wherein the flame guide is installed at a lower portion of the burner.

3. The flame guide unit as claimed in claim 1, wherein the flame guide is comprised of:
a flange joined with the burner;
a cylinder-shape guide body having an opening at both ends and extending from the flange to a predetermined length; and,
a cooler for preventing the guide body from being overheated by supplying cooling water to the guide body and for discharging the cooling water that is progressed to a designated path of the guide body.

4. The flame-guide unit as claimed in claim 1, wherein an extended length toward the longitudinal direction of the flame guide is shorter than the distance between the burner and the suctions.

5. The flame-guide unit as claimed in claim 1, wherein an internal surface of the flame guide is made of a thermal-insulation material.

6. The flame guide unit as claimed in claim 1, wherein the internal surface has a high heat reflection rate.
